(19) United States
(12) Patent Application Publication
(10) Pub. No.: US 2026/0337061 A1
(43) Pub. Date: Oct. 29, 2026

(54) VALVE BASED WATER SOFTENER SYSTEM AND METHOD

(71) Applicant: Pentair, Inc., Minneapolis, MN (US)

(72) Inventors: Ajit Kumar Tulo, Greater Noida, Uttar Pradesh (IN); Neerav Barola, Noida, Uttar Pradesh (IN)

(21) Appl. No.: 19/124,354

(22) PCT Filed: Oct. 27, 2023
(86) PCT No.: PCT/US2023/078116

§ 371 Date: Apr. 25, 2025

Related U.S. Application Data
(60) Provisional application No. 63/381,247, filed on Oct. 27, 2022.

(51) Int. Cl. C02F 1/42

(52) U.S. Cl. CPC C02F 1/42; C02F 2201/005

(57) ABSTRACT

A water softener system is provided. The system includes a housing, a brine tank disposed within the housing, a water softener tank disposed within the housing and in fluid communication with the brine tank, and a valve assembly in fluid communication with the water softener tank and having a first valve, a second valve and a third valve, each valve having a valve inlet, a first outlet, and a second outlet. The valve assembly does not include any per- or polyfluorinated substances.

### CROSS-REFERENCE TO RELATED APPLICATIONS

This application claims the benefit of U.S. Provisional Patent Application No. 63/381,247, filed Oct. 27, 2022, entitled TRIPLE VALVE WATER SOFTENER, the entire contents of which are incorporated herein by reference.

### TECHNICAL FIELD

This disclosure generally relates to water treatment systems. More particularly, the embodiments of the present disclosure relate to a valve based water softener system and method designed to control water flow therethrough.

### BACKGROUND

In general, water softening involves converting hard water to soft water by removing calcium and magnesium contents from hard water. In some known systems, a single valve is used in a water softening system to direct the flow of fluid/water in each cycle. The single valve has multiple parts and involves a composite structure with a multiport valve, which is controlled using cams and/or gears. Also, many prior art valves utilize moving piston parts. The moveable parts may create an issue with operational timings and throughput of flow control of water for the water treatment systems. A large number of moveable parts in the valve may also increase the amount of maintenance necessary to keep the water softener operational. Therefore, a simplified valve arrangement for controlling the water flow path through the water softening system through various water treatment cycles would be useful.

Further, some water softening systems are bulky and have a large footprint. Therefore, there is a need for a system with a smaller footprint and fewer parts to reduce the amount of maintenance necessary for the system. Relatedly, water softening systems are manually operated. There is a need for a water softening system that has automated control of one or more valves of the water softening system.

Still further, many systems incorporate components that may include Per- and Polyfluorinated substances (PFAS). Systems utilizing such components may cause the water flowing therethrough to acquire some amount of PFAS via leaching or other methods, which in turn, may be harmful. Therefore, it would be useful to have a water softener and valve system that minimizes the number of PFAS components and/or minimizes the surface area of PFAS components that may meet water.

### SUMMARY

A water softener system is provided. The water softener system comprises a head, a water softener tank connected to the head through a center tube, and a controller. The head includes an inlet, an outlet, and a center tube connected to the inlet and the outlet. The water softener system further includes a first valve, a second valve, and a third valve. The controller operates each of the first valve, the second valve, and a third valve in a first operational state or a second operational state to control a flow of fluid through the water softener system.

A method for controlling a flow of fluid through a water softener system is provided. The method includes the step of providing a water softener system having a controller, a first valve, a second valve, and a third valve. The method comprises the step of receiving a command from a user to operate the water softener system in a first operational cycle. The method also comprises the step of operating via a controller each of the first valve, the second valve, and the third valve in a first state or a second state to control the flow of fluid in the water softener system.

In some embodiments, each of the first valve, the second valve, and the third valve is provided in the form of a motorized 3-way L-port or T-port valve.

In some embodiments, the flow of fluid is controlled in one of the operational cycles defined by a service cycle, a backwash cycle, a brine draw cycle, a slow rinse cycle, a rapid rinse cycle, a brine tank refill cycle, and/or a bypass cycle.

In some embodiments, the flow of fluid is designed to convert hard water to soft water.

In some embodiments, during the service cycle, the first valve, the second valve, and the third valve are operated in the first state.

In some embodiments, during the backwash cycle, the first valve and the third valve are operated in the second state, and the second valve is operated in the first state, where the first state and the second state have different operational conditions with respect to each other.

In some embodiments, during the brine draw cycle, the first valve and the second valve are operated in the second state, and the third valve is operated in the first state, where the first state and the second state are different operational conditions with respect to each other.

In some embodiments, during the slow rinse cycle, the first valve and the second valve are operated in the second state, and the third valve is operated in the first state, where the first state and the second state have different operational conditions with respect to each other.

In some embodiments, during the fast/rapid rinse cycle, the first valve and the third valve are operated in the first state, and the second valve is operated in the second state, where the first state and the second state have different operational conditions with respect to each other.

In some embodiments, the fluid is provided through an inlet line through a flow meter/indicator, and the first valve. The fluid is sent to the inlet and through the water softener tank, exits from the outlet, reaches the second valve, and exits from an outlet line during the service cycle.

In some embodiments, the fluid is provided through the first valve, enters the outlet through the second valve, enters the water softener tank, exits through the inlet, passes through the third valve, and drains out through a drain line during the backwash cycle.

In some embodiments, the fluid is provided through a brine line through the first valve and is mixed with brine solution to form a mixed fluid. The mixed fluid enters the inlet and the water softener tank through the third valve and exits from the outlet to a drain line through the second valve during the brine draw cycle.

In some embodiments, the fluid is provided through a brine line through the first valve, passes through the third valve, enters the inlet and the water softener tank, and exits from the outlet to a drain line through the second valve during the slow cycle rinse cycle.

In some embodiments, the fluid is provided through an inlet line through the first valve, enters the water softener tank through the inlet, and exits from the outlet to a drain line through the second valve during the fast/rapid cycle rinse cycle.

In some embodiments, the fluid is provided through the inlet line through the first valve and flows to a brine tank through the third valve for refilling the brine tank during the fast/rapid cycle rinse cycle.

In some embodiments, the fluid passes through the first valve to directly supply the fluid to a user through an outlet line during the backwash cycle, the brine draw cycle, and/or the slow rinse cycle.

In some embodiments, the water softener system reverses the flow of fluid without using any moving piston parts.

In one embodiment, a water softener system is provided. The system includes a housing, a brine tank disposed within the housing, a water softener tank disposed within the housing and in fluid communication with the brine tank, and a valve assembly in fluid communication with the water softener tank and having a first valve, a second valve and a third valve, each valve having a valve inlet, a first outlet, and a second outlet. The valve assembly does not include any per- or polyfluorinated substances.

In some embodiments, the housing of the water softener system includes a cover removably coupled to a base and defining an enclosure to retain at least a portion of the water softener system. The brine tank includes sodium designed to recharge the water softener. The water softener tank is disposed within the housing and is in fluid communication with the valve assembly, which protrudes upwardly from an exterior of the housing. The water softener tank includes a container having a resin bed to facilitate treatment of fluid flowing therethrough. The valve assembly is engaged with the water softener tank via a threaded connection.

In some embodiments, the valve assembly is provided in the form of a valve head, a connector plate, a drain manifold, a main manifold, and the first valve, the second valve, and the third valve define a valve sub assembly. The valve sub assembly is in fluid communication with the drain manifold and the main manifold. The drain manifold is coupled between the second valve and the third valve to facilitate draining the fluid from the system.

In other embodiments, the first valve, the second valve, and the third valve are provided in the form of a motorized 3-way L-port valve or a 3-way T-port valve. The main manifold is provided in the form of a housing having a first conduit, a second conduit, and a third conduit that are in fluid communication with the first valve, the second valve, and the third valve, respectively. The first conduit is in communication with a flow sensor, which is designed to measure the linear or nonlinear mass or volumetric flow of the fluid through the main manifold.

In some embodiments, the water softener system also includes a controller for operating each of the first valve, the second valve, and the third valve in a first state or a second state, to control a flow of fluid in the water softener system. The controller facilitates operating the water softener system in one of a service cycle, a backwash cycle, a brine draw cycle, a slow rinse cycle, a rapid rinse cycle, a brine tank refill cycle, and/or a bypass cycle. The first valve, the second valve, and the third valve are operated in a first state during the service cycle, wherein each valve has an inlet open, a second outlet open, and a first outlet closed. Also, the first valve and the third valve are operated in a second state, wherein the first valve and the third valve have open inlets, open first outlets, and closed second outlets, and the second valve is operated in the first state, wherein the second valve has an open inlet, a closed first outlet, and an open second outlet during the backwash cycle.

A valve assembly for a water softener system is also provided. The valve assembly includes a valve head having a body with an inlet and an outlet that are substantially axially aligned. The valve head is in fluid communication with a water softener tank. The valve assembly also includes a connector plate having a plurality of connectors to facilitate fluid communication between the water softener tank and the inlet and the outlet of the valve head, and a valve sub assembly defined by a first valve, a second valve, and a third valve. The valve assembly further includes a main manifold having a housing with three substantially cylindrical conduits, a flow sensor, and a venturi assembly. The main manifold is designed to facilitate the flow of fluid between the first valve, the second valve, and the third valve, and the water softener tank. The valve assembly also includes a controller that selectively operates the first valve, the second valve, and the third valve in various operational states.

The valve sub assembly is in fluid communication with the inlet and the outlet of the valve head, which is coupled to the water softener tank. The main manifold includes a port in fluid communication with a brine tank. At least one of the first valve, the second valve, and the third valve has a coupling plate. The water softener system is operated in at least one of a service cycle, a backwash cycle, a brine draw cycle, a slow rinse cycle, a rapid rinse cycle, a brine tank refill cycle, or a bypass cycle.

In one embodiment, a method of operating a water softener system having a tank, and at least three valves coupled between a manifold and a valve head is provided. The method includes determining a first operating state of the system, monitoring the performance of each of the three valves via the controller, receiving an instruction from the controller to change the first operating state of at least one of the three valves to a second operating state of the system that is different than the first operating state, and changing at least one of three valves to the second operating state based on the instruction.

In further embodiments, the operating state is at least one of a service cycle, a backwash cycle, a brine draw cycle, a slow rinse cycle, or a rapid rinse cycle. In some embodiments, the controller includes a circuit board that is a 4 channel relay.

### DESCRIPTION OF THE DRAWINGS

FIG. 1 is a top front right side isometric view of a water softener system according to one embodiment;

FIG. 2 is a top front left side isometric view of the water softener system of FIG. 1;

FIG. 3 is a top rear left side isometric view of the water softener system of FIG. 1;

FIG. 4 is a right side plan view of the water softener system of FIG. 1;

FIG. 5 is a top plan view of the water softener system of FIG. 1;

FIG. 6 is an exploded view of a valve assembly of the water softener system of FIG. 1;

FIG. 7 is a top front right side isometric view of the valve assembly of FIG. 6;

FIG. 8 is a top front right side isometric view of the valve assembly of FIG. 6 with a flow sensor and an adapter removed therefrom;

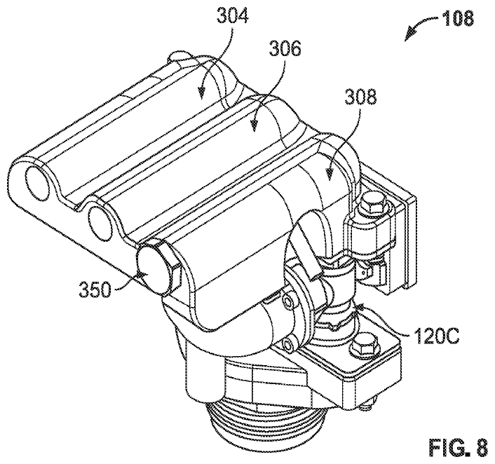

FIG. 9 is a top plan view of the valve assembly of FIG. 8;

FIG. 10 is a right plan view of the valve assembly of FIG. 8;

FIG. 11 is a schematic diagram of the water softening system of FIG. 1;

FIG. 12 is a schematic diagram depicting a fluid flow path of fluid passing through the water softener system of FIG. 11 in a service cycle;

FIG. 13 is a schematic diagram depicting a fluid flow path of fluid passing through the water softener system of FIG. 11 in a backwash cycle;

FIG. 14 is a schematic diagram depicting a fluid flow path of fluid passing through the water softener system of FIG. 11 in a brine draw cycle;

FIG. 15 is a schematic diagram depicting a fluid flow path of fluid passing through the water softener system of FIG. 11 a slow rinse cycle;

FIG. 16 is a schematic diagram depicting a fluid flow path of fluid passing through the water softener system of FIG. 11 in a fast/rapid rinse cycle and/or a brine tank refill cycle;

FIG. 17 is a flow diagram of operating the water softener of FIG. 1 in any of the operational states described herein; and

FIG. 17A is a flow diagram of operating the water softener system of FIG. 1 and updating an operating parameter.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

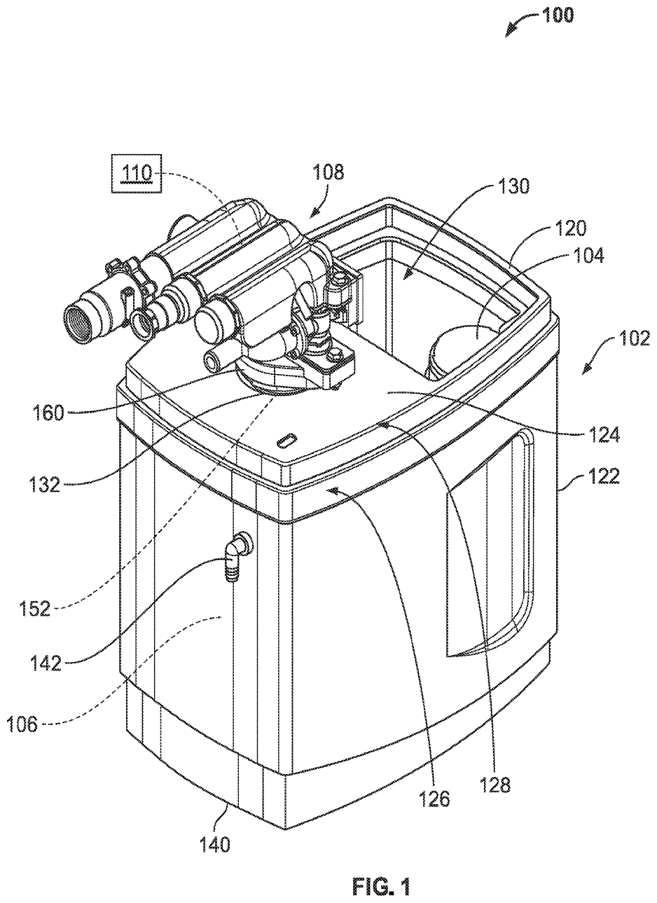

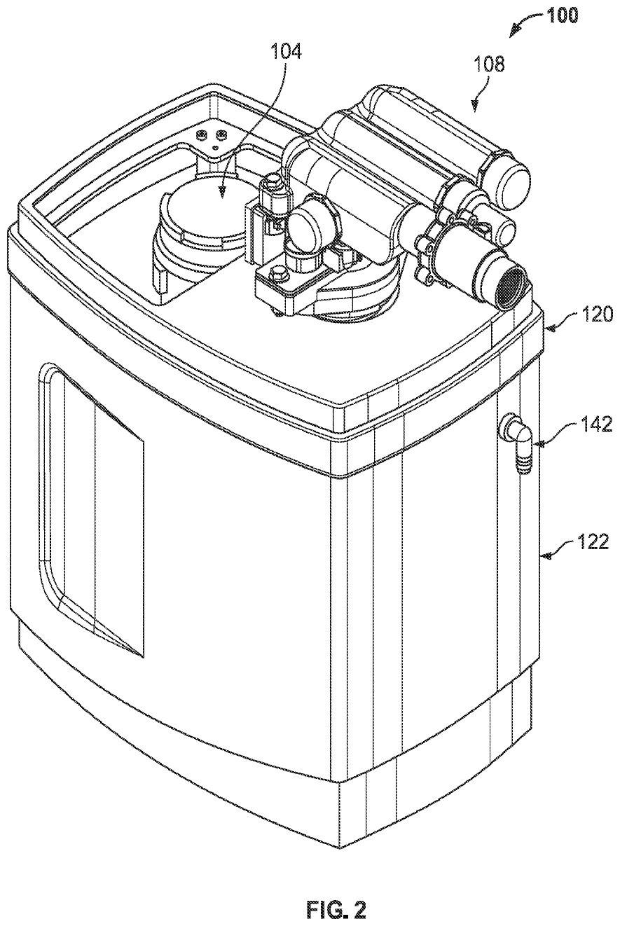

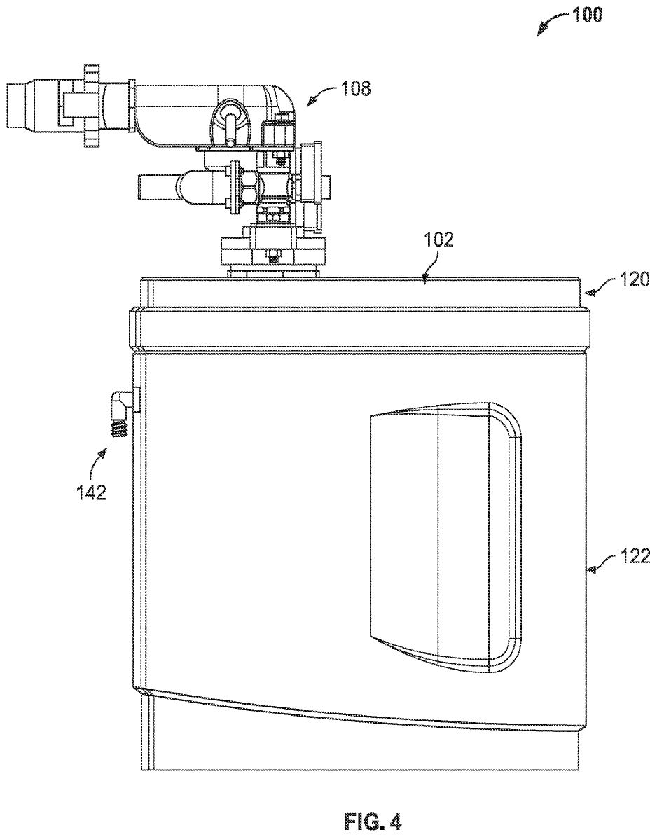

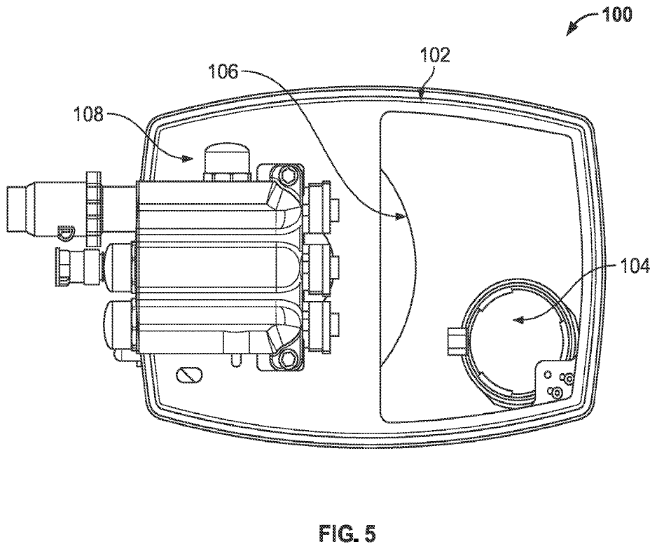

Referring to FIGS. 1-5, an exemplary valve based water softener system 100 is shown. The valve based water softener system 100 is designed to convert hard water into soft water and to operate in a number of states discussed herein, such as a service cycle and/or a regeneration cycle and/or recharging cycle.

The valve based water softener system 100 includes a housing 102, a brine tank 104, a water softener (e.g., mineral) tank 106, a valve assembly 108, and a controller 110 in communication with the water softener system 100. A fluid (e.g., water) from a water source may flow into the water softener system 100 via the valve assembly 108, pass through the water softener tank 106, and exit out of the valve assembly 108 to facilitate the process of de-ionization/ion exchange of the fluid. In this process, water passes through the mineral tank where positively-charged calcium and magnesium ions are exchanged with sodium onto the negatively-charged resin beads. The calcium and magnesium are retained on the media within the resin tank while the remainder of the water with sodium ions flows out of the water softener system 100, resulting in softened water. Eventually, all sodium ions are exchanged with the magnesium and calcium and the resin beads fill with calcium and magnesium and the resin beads need to be regenerated via the brine tank 104.

The water softener system 100 may include a number of other components such as a flow control orifice, a brine line flow control orifice, a drain line flow control restrictor, various conduits and lines, and other components.

Turning to FIG. 1, the housing 102 includes a cover 120 removably coupled to a base 122. The cover 120 may have a horizontal top surface 124 with a flange 126 extending downwardly therefrom and around the periphery of the cover 120 to form a substantially continuous edge 111. The flange 126 is designed to engage with the base 122 of the water softener system 100 to form an at least partially enclosed system 100. The cover 120 further may include an enlarged opening 130 formed therethrough providing easy access to the brine tank 104, the water softener tank 106, and other components stored therein. The enlarged opening 130 may be provided as a substantially rectangular cutout disposed on an end of the top surface 124. In some instances, a releasable cover or hatch (not shown) may be included to selectively block the enlarged opening 130.

The top surface 124 of the housing 102 further includes a smaller opening 132 designed to support the valve assembly 108 and provide fluid communication between the internal components of the water softener system 100 and the fluid source.

The base 122 may be imparted with a substantially rectangular shape, similar to the shape of the cover 120, such that the base 122 and cover 120 can releasably attach. The base 122 includes a first pair of rounded opposing walls and a second pair of lateral walls connected to the first pair of walls to define an enclosure. The base 122 further includes a lower surface 140 extending between the first pair of walls and the second pair of walls. The base 122 also may include a drain port 142 that is in fluid communication with the tank 106 to prevent fluid (e.g., water) overflow of the base 122 and/or the housing 102.

The brine tank 104 is provided in the form of an enclosure having sodium therein. The water softener tank 106 is recharged with sodium from the brine tank 104 solution and displaces calcium and magnesium, which is flushed down the drain during the backwashing operation of the water softener system 100. In one embodiment, the brine tank 104 is provided as a separate tank from the water softener tank 106. Alternatively, the brine tank 104 may be located within water softener tank 106.

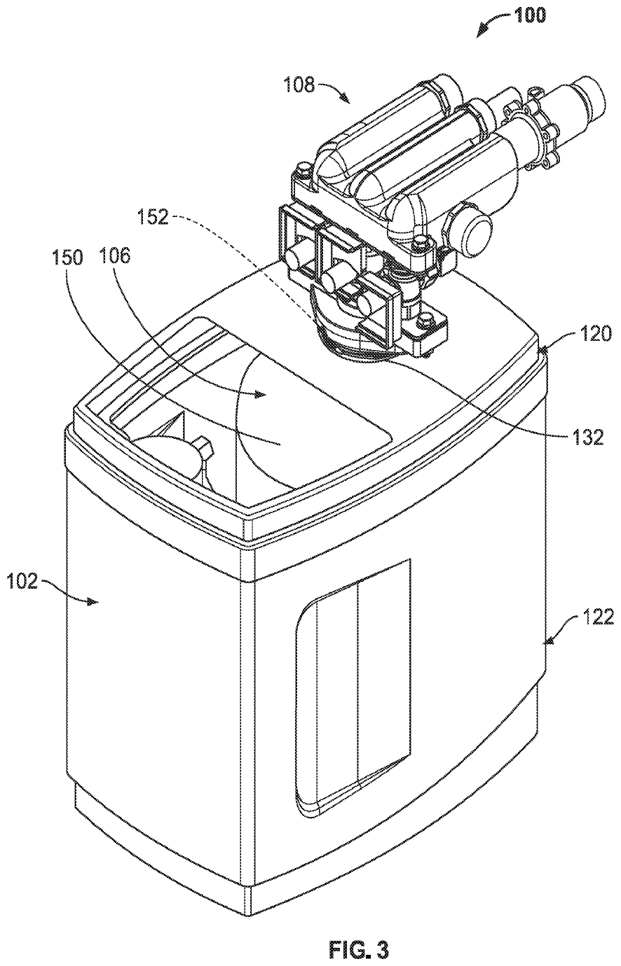

As best seen in FIG. 3, the water softener tank 106 is provided in the form of a container 150 designed to fit within the base 122 of the housing 102 and is further designed to be positioned underneath at least a portion of the cover 120 and/or the surface 124. The top of the water softener tank 106 is configured to align with and be in fluid communication with at least a portion of the valve assembly 108 such that a fluid (e.g., water) can flow through the opening 132 between the water softener tank 106 and the valve assembly 108.

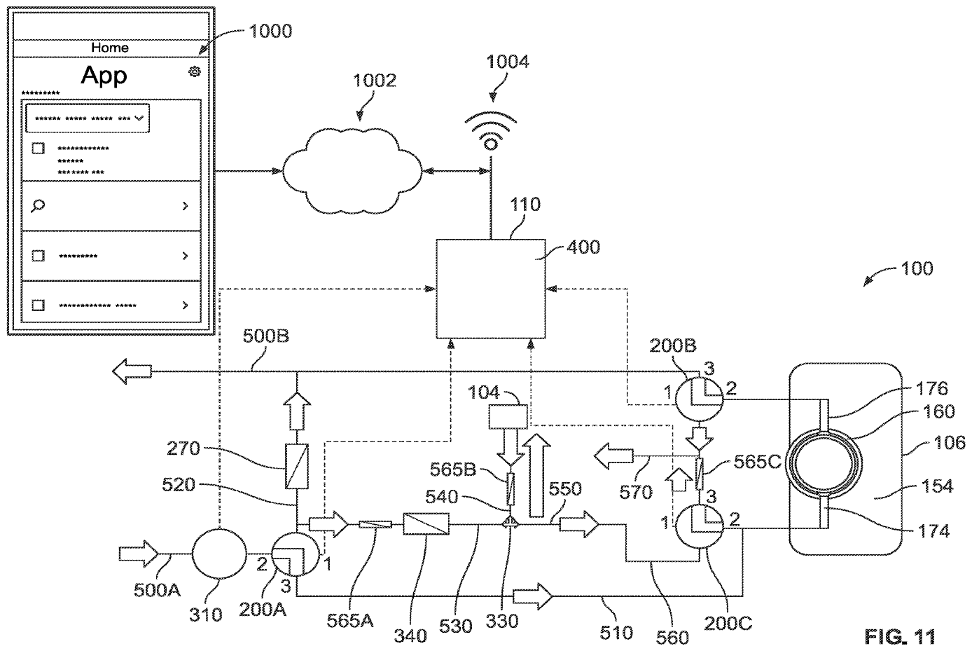

The water softener tank 106 extends upwardly and terminates at a neck 152 configured to engage the valve assembly 108. The valve assembly 108 can include a threaded portion designed to engage with corresponding threads that circumscribe the neck 152 of the water softener tank 106. The water softener tank 106 and the valve assembly 108 can be joined by other known methods, such as a friction fit, a twist lock, a latch, or any other connection mechanism. As such, at least one seal may be formed between the valve assembly 108 and the water softener tank 106 Also, the water softener tank 106 may include a solution of resin or a resin bed 154 (shown in FIG. 11) to facilitate treatment of the fluid flowing therethrough. The resin bed 154 can be provided in the form of an ion exchange bed. In some embodiments, the resin bed 154 can include two or more types of resin (i.e., a mixed resin bed).

The valve assembly 108 includes various components designed to provide fluid communication between the fluid (e.g., water) source and the water softener tank 106. The valve assembly 108 and various parts described herein are provided such that it is free of Per- and Polyfluorinated substances (PFAS). In some instances, none of the components of the valve assembly 108 include PFAS. In other instances, almost all of the components of the valve assembly 108 are free from PFAS. In further instances, the number of components within the valve assembly 108 system utilizing PFAS containing compounds is less than 10% of the total number of components of the valve assembly 108. For example, one or more of the valve assembly 108 components may be imparted one or more of Polyoxymethylene (POM), Polyether ether ketone (PEEK), and/or Ultra-High Molecular Weight Polyethylene (UHMWPE).

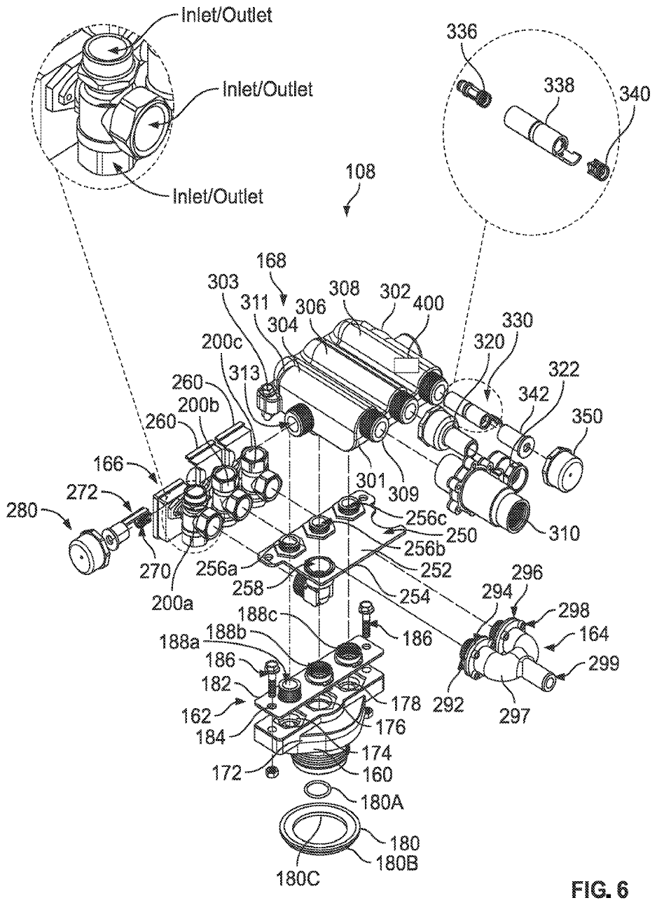

Turning to FIG. 6, the valve assembly 108 is provided in the form of a valve head 160, a connector plate 162, a drain manifold 164, a three valve sub assembly 166, and a main manifold 168.

The valve head 160 is defined by a body 172 having an inlet 174 and an outlet 176 that are substantially axially aligned and spaced evenly with respect to each other. Further, the valve head 160 may include an opening (e.g., a third opening) 178 that is also axially aligned and spaced evenly with respect to the inlet 174 and the outlet 176. A fluid (e.g., water) enters the water softener tank 106 as an untreated, or hard, fluid from the inlet 174, passes through the water softener tank 106, and exits from the water softener tank 106 through the outlet 176 as a treated or soft fluid. In some embodiments, the valve head 160 can be used in other fluid flow systems, such as a sand filter.

The valve head 160 further may include at least one coupling or seal 180 designed to be positioned between the water softener tank 106 and the valve head 160. The seal 180 may be provided in the form of three nested seals 180A, 180B, and 180C disposed on an under side of the valve head 160 to help prevent fluid from leaking into or out of the water softener tank 106. In some embodiments, a first seal 180A is provided in the form of an O-ring that circumscribes a bottom portion of the valve head 160. The first seal 180A is placed to prevent leakage/mixing of the fluid/water. In some embodiments, a second seal 180B is provided in the form of a larger ring that acts as a locking mechanism to join the water softener tank 106 and the valve head 160. The second seal 180B is designed to lock the valve head 160 to the water softener tank 106. In some embodiments, a third seal 180C is provided in the form of an O-ring placed between the water softener tank 106 and the valve head 160, and the third seal 180C also is designed to prevent the fluid/water leakage from the connection between the valve head 160 and the water softener tank 106 to the exterior of the system 100. The valve head 160 and one or more of its components may be provided as rubber. Alternatively, the valve head 160 may be a flexible material such as a hard plastic. In some instances, one, two, or all three seals 180A, 180B, and 180C may be omitted from the valve head 160.

The connector plate 162 is designed to couple to a top surface 182 of the valve head 160. The connector plate 162 may include a plurality of cylindrical openings 184 such that the connector plate 162 may be removably coupled to the top surface 182 of the valve head 160 with one or more coupling mechanisms 186. As depicted, the coupling mechanism 186 is provided in the form of two screws designed to be inserted through fastener openings disposed on opposing ends of in the connector plate 162. In other instances, the coupling mechanism 186 may be provided in other forms, and/or the connector plate 162 may be secured in other manners. In further instances, the connector plate 162 may be omitted from the system 100.

Moreover, the connector plate 162 may include a plurality of connectors 188 to facilitate fluid communication between the valve head 160 and the connectors, such as a first connector 188a configured to align with the inlet 174, a second connector 188b configured to align with the outlet 176, and a third connector 188c configured to align with the opening 178. Each connector 188a, 188b, and 188c may have a substantially cylindrical shape and may be provided as a metal. Alternatively, each connector 188a, 188b, and 188c may have any shape and/or be provided as a hard plastic or other material. The connector plate 162 and plurality of connectors 188 are configured to facilitate coupling the valve head 160 to the main manifold 168.

Each connector 188a, 188b, and 188c is configured to couple to and provide fluid communication between valves associated with the three valve sub assembly 166 and the main manifold 168. The three valve sub assembly 166 includes a first valve 200A, a second valve 200B, and/or a third valve 200C. The valves 200A-200C are designed to control the fluid flow through the valve based water softener system 100 via the valve assembly 108.

The three valve sub assembly 166 further may include a valve plate 250 having at least various components designed to interact with the connectors 188a-188c, respectively of the connector plate 162. The valve plate 250 has an upper surface 252 and an opposing lower surface 254 having a plurality of connectors 256a, 256b, and 256c extending therethrough and configured to align with the connectors 188a, 188b, and 188c, respectively. In one embodiment, the connectors 256a, 256b, and 256c protrude outwardly from the upper surface 252 of the valve plate 250. Moreover, the connectors 256a, 256b, and 256c may be substantially parallel and/or axially aligned with each other. Further, the connectors 256a, 256b, and 256c may be evenly spaced with respect to one another.

Additionally, the valve plate 250 may contain another connector 258 protruding downwardly from the lower surface 254 of the valve plate 250 and further may be axially aligned with the connector 256a, but may not be axially aligned with the connector 256b and/or the connector 256c. Moreover, the connector 258 may be provided in the form of an elbow shaped connector configured to engage to at least one of the valves 200A, 200B, and/or 200C.

Each connector 256a, 256b, and 256c may be configured to couple to and/or receive at least one of the valves 200A, 200B, and/or 200C. More specifically, as shown in FIG. 6, the valve 200A is designed to engage the first connector 188a, the connector 256a, and connector 258 and further may be in fluid communication with the inlet 174. The valve 200B is designed to couple between the second connector 188b and the connector 256b and further may be in fluid communication with the outlet 176, and the valve 200C is designed to couple between the third connector 188c and the connector 256c and further may be in fluid communication with the opening 178.

Each of the first valve 200A, the second valve 200B, and the third valve 200C may be provided in the form of a motorized 3-way L-port or 3-way T-port valve. In alternative embodiments, the valves 200A, 200B, and/or 200C can be a 2-way valve or another type of valve, such as a check valve, a ball valve, a butterfly valve, a gate valve, a globe valve, an angle valve, a plug valve, a diaphragm valve, or any other valve in the known art for the water softener system 100. Each of the valves 200A, 200B, and/or 200C may vary in size. In some instances, the valves 200A, 200B, and/or 200C may be between about ⅛ inch or about 0.32 centimeters to about 3 inches or about 7.62 centimeters, or less than about 5 centimeters. For example, in some embodiments, the valves 200A, 200B, and/or 200C may be ½ inch (in.) or 1.27 centimeters (cm.) valve, or ¾ inch or 1.9 centimeters. It is further understood that each of the valves may be smaller or larger, depending on the embodiment and water treatment application.

In one embodiment, each valve 200A, 200B, and/or 200C may have one inlet such that fluid may flow into the valve 200A, 200B, and/or 200C through the valve inlet, and two outlets (namely, a first valve outlet and a second valve outlet) such that the fluid that enters the valve 200A, 200B, and/or 200C through the valve inlet, exits through at least one of the first valve outlet and/or the second valve outlet. Each valve 200A, 200B, and/or 200C may include at least one ball (not shown) therein to facilitate changing the exit path of the fluid. Alternatively, each valve 200A, 200B, and/or 200C may be provided in the form of another type of valve, such as a two-way valve.

In addition, each valve 200A, 200B, and/or 200C may have a coupling plate 260 coupled to at least a portion thereof. More specifically, the coupling plate 260 may be joined to the back surface of each of the valves 200A, 200B, and/or 200C. The coupling plate 260 is designed to facilitate coupling at least one of the valves 200A, 200B, and/or 200C to at least a portion of the housing 102 (e.g., the edge 111) of the water softener system 100. The coupling plate 260 also facilitates supporting the weight of the valve assembly 108 components. The valve plate 250 may be provided as a metal or another material such as a hard plastic.

The three valve sub assembly 166 further includes a check valve 270, a check valve retainer 272, and at least one end cap 280. In one embodiment, the check valve 270 is positioned between the valve 200A and the valve 200B (e.g., a first outlet of the valve 200B and the second outlet of the valve 200A), and the check valve 270 may prevent the backflow of fluid into the system 100 to prevent the loss of fluid (e.g., soft/treated water), discussed further herein.

As discussed herein, the check valve 270 can be provided in the form of a ball valve, a butterfly valve, a gate valve, a globe valve, an angle valve, a plug valve, a diaphragm valve, or any other valve in the known art. The valve 270 may vary in size.

The three valve sub assembly 166 is in fluid communication with the drain manifold 164 and the main manifold 168. The drain manifold 164 is configured to couple between at least the valves 200B and 200C to enable fluid flowing through at least one valve 200B and/or 200C to drain from at least one of the valve assembly 108 and/or the valve based water softener system 100. The drain manifold 164 may have a Y-shaped body defined by a first side 292 having a first connector 294 and an opposing second side 296 with a second connector 298 and a body 297 extending between the first side 292 and the second side 296. More particularly, the first side 292 and/or the first connector 294 is designed to couple to the valve 200B, and the second side 296 and/or the second connector 298 is designed to couple to the valve 200C. In addition, the drain manifold 164 further includes a substantially cylindrical shaped conduit 299 extending outwardly from the body 297 to facilitate draining and/or flow of the fluid from at least one of the valves 200B and/or 200C. In alternative embodiments, the drain manifold 164 may be provided in a different shape.

Continuing with FIGS. 6, the valve assembly 108 also includes the main manifold 168 having a flow sensor 310, an outlet adapter 320, a venturi assembly 330 having a venturi 336, a venturi housing 338, and a check valve 340, and/or a venturi assembly retainer 342 with at least one end cap 350. The main manifold 168 includes a housing 302 defining optional flow paths for the fluid therethrough. The upper surface 252 of the plate 250 may be coupled to a lower surface 301 of the main manifold 168 with at least one coupling mechanism 303, such as a screw.

The housing 302 of the main manifold 168 may include a first substantially cylindrically shaped straight conduit 304. In one embodiment, the housing 302 further includes a second substantially cylindrically shaped straight conduit 306 and a third substantially cylindrically shaped straight conduit 308, wherein the conduits 304, 306, and/or 308 are substantially parallel to one another and are evenly spaced apart. Each conduit 304, 306, and/or 308 extends between a first end 309 and a second end 311 of the housing 302. Additionally, each conduit 304, 306, and/or 308 is in fluid communication with at least one of the valves 200A, 200B, and/or 200C, respectively.

Additionally, the first conduit 304 may in communication with or include the flow sensor 310. The flow sensor 310 may include a flow meter designed to measure the linear or nonlinear mass or volumetric flow of the fluid through at least one of the main manifold 168 and/or the valve based water softener system 100. In one example, the flow sensor 310 is coupled to the first end 309 of the conduit 304. Further, the flow sensor 310 provides measurements of the flow rate such that the measurement values can be communicated via a network or controller 110, discussed herein, to ensure that the pressure and/or flow throughout the valve based water softener system 100 is stable and accurate.

The housing 302 also may include an opening 313 formed within at least one side thereof (e.g., within or near the conduit 304) that is designed to receive the at least one check valve 270 (e.g., a one-way valve) therein. The check valve 270 facilitates moving the fluid through the valve assembly 108 and/or the system 100. In one instance, the check valve 270 is disposed within the check valve retainer 272, and at least one end cap 280 is designed to removably couple the check valve 270 and/or the check valve retainer 272 to the main manifold 168.

Moreover, in one instance, the second end 311 of the conduit 304 is designed to couple to at least one of the connector 256a of the valve plate 250 and/or the valve 200A to facilitate fluid communication with at least one of the valve 200A and/or the inlet 174.

The second conduit 306 may include an adapter 320 and a nested coupling 322. The coupling 322 may act as a quick connect fitting to increase the ease of coupling the adapter 320 to the second conduit 306.

Also, in one instance, the second end 311 of the conduit 306 is designed to couple to at least one of the connector 256b of the valve plate 250 and/or the valve 200B to facilitate fluid communication with at least one of the valve 200B and/or the outlet 176.

Turning to the third conduit 308, in one instance, the second end 311 of the conduit 308 is designed to couple to at least one of the connector 256c of the valve plate 250 and/or the valve 200C to facilitate fluid communication with at least one of the valve 200C and/or the opening 178.

Also, the third conduit 308 may include a venturi assembly 330 coupled thereto and/or therein. In one instance, the venturi assembly 330 is inserted into the conduit 308. The venturi assembly 330 is substantially responsible for cycling water through the system 100 by creating suction to move the fluid and/or to create suction to move brine from the brine tank 104 into the resin bed 154. The venturi assembly 330 also may facilitate measuring the speed of the fluid by measuring the pressure changes from one point to another along the venturi assembly 330 and/or the valve based water softener system 100. If the venturi assembly 330 were to become plugged with sand, silt, dirt, or the like, the valve based water softener system 100 would not work properly to soften hard water.

Additionally, the venturi assembly 330 includes the venturi 336, the venturi housing 338, the check valve 340, a venturi assembly retainer 342, and at least one end cap 350. The venturi 336 may provide flow regulation in response to pressure changes within the valve based water softener system 100. The venturi housing 338 is configured to surround and retain the venturi 336 and the check valve 340 therein, and the venturi housing 338 may further facilitate fluid flow between the venturi 336 and the check valve 340. Moreover, the venturi assembly retainer 342 may couple and/or hold the venturi 336, the venturi housing 338, and/or the check valve 340 in place within the conduit 308. Additionally, the end cap 350 is designed to couple to the end 309 of the conduit 308 and hold the venturi assembly 330 and/or the venturi assembly retainer 342 within the conduit 308.

The check valve 340 can be provided in the form of a ball valve, a butterfly valve, a gate valve, a globe valve, an angle valve, a plug valve, a diaphragm valve, or any other valve in the known art. Valve 340 may vary in size.

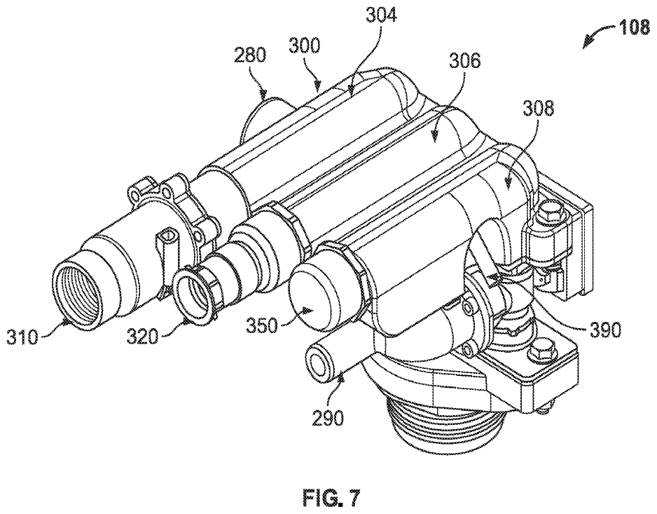

As best seen in FIG. 7, the housing 302 may further include a port 390. The port 390 may be in fluid communication with at least one of the venturi assembly 330, the check valve 340, and/or a brine line of the brine tank 104.

Additionally, the water softener system 100 may include at least one variable orifice or flow control restrictor or valve 565A, 565B, and/or 565C (shown in FIG. 11), as discussed herein. The flow restrictors 565A, 565B, and/or 565C are configured to only allow a particular fluid flow therethrough depending on the orifice opening (e.g., the size of the orifice opening).

The flow restrictor 565A can be positioned within the conduit 308 (e.g., within the venturi housing 338) such that the flow restrictor 565A is in fluid communication with the venturi 330 (e.g., the flow restrictor 565A may be upstream of the venturi 330).

In one embodiment, the flow restrictor 565B is a brine line flow control restrictor is positioned within or near the brine line and/or port 390 and may be positioned within a line 540, discussed herein. In one instance, the flow restrictor 565C is a drain line flow control restrictor and is coupled to and/or positioned within the drain manifold 164 (e.g., inside the conduit 299).

Each of the flow control restrictors or valves 565A, 565B, and/or 565C can be provided in the form of a valve, an orifice, a slot, an annulus, a cone restrictor, or other flow restrictors or devices that inhibit fluid flow therethrough. Each of the restrictors 565A, 565B, and/or 565C may vary in size.

It is further understood that the water softener system 100 can include more or fewer valves, flow restrictors, pumps, and/or flow meters than illustrated in the figures herein.

One or more components of the water softener system 100 can be communicatively coupled to the controller 110. As discussed in more detail herein, the controller 110 can receive information from the system 100, interpret the information, and send instructions back to the water softener system 100 to execute a particular operation.

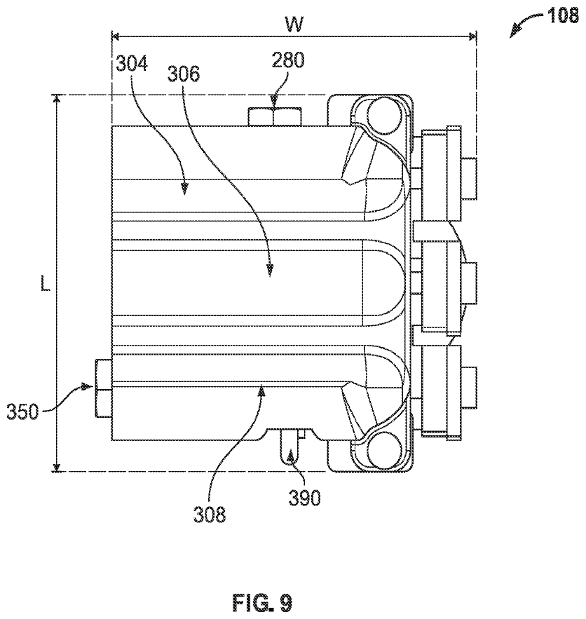

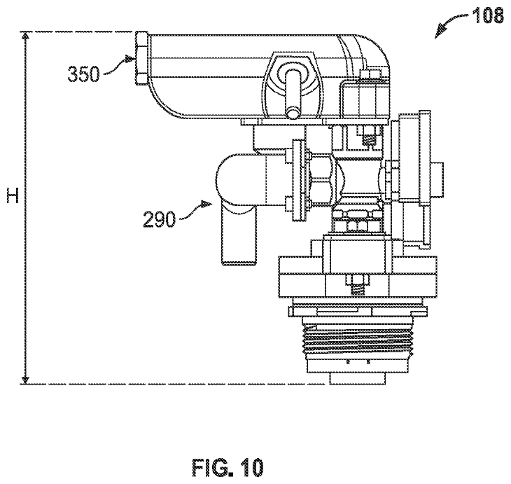

As shown in FIGS. 9 and 10, the embodiments described herein for the system 100 are imparted with a smaller volumetric and cross-sectional footprint than known prior art valve assemblies for water softener systems. In one embodiment, the valve head 160 may have a width W, a height H, and a length L. In some instances, the width W may be between about 100 mm to about 250 mm, or less than about 200 mm. In additional instances, the height H may be between about 150 mm to about 250 mm, or less than about 200 mm. In further instances, the length may be between about 150 mm to about 250 mm, or less than about 200 mm. By way of example, the width W may be about 200 mm, the height H may be about 201 mm, and the length L may be about 201 mm. Returning to FIG. 6, one or more components of the water softener system 100 can be communicatively coupled to a controller 110. As discussed in more detail herein, the controller 110 can receive information from the system 100, interpret the information, and send instructions back to the water softener system 100 to execute a particular operation.

The valve based water softener system 100 may include an optional circuit board 400 that may be integrally formed within and/or coupled to the housing 302 of the main manifold 168 to facilitate collecting, storing, transmitting, and/or receiving data. The circuit board 400 further may be designed to communicate with the controller 110. In one embodiment, the circuit board 400 may be with a 4-channel relay (e.g., 3 of the 4 channels are utilized) with ESP 32 to facilitate controlling the operation of the valve assembly 108.

The controller 110 is in electrical communication with and designed to automatically or semi-automatically control at least one of the first valve 200A, the second valve 200B, and/or the third valve 200C, and/or the flow meter/indicator 310. In some embodiments, the controller 110 is designed to automatically operate (e.g., be communicatively coupled to) each of the first valve 200A, the second valve 200B, and/or the third valve 200C between an open state, a partially open state, a closed state, and/or a partially closed state to facilitate controlling flow of fluid in the water softener system 100, which is explained below. In some instances, the flow meter or flow indicator may refer to an indicator for measuring any type of fluid (e.g., hard water and/or soft water) and the flow rate in which it is flowing. Further, the flow meter or flow indicator may also be designed to determine/calculate how much fluid/water flows through it.

Moreover, in some instances, the controller 110 may be designed to automatically operate one or more components within the valve based water softener system 100, such as the check valve 270, the flow sensor 310, the adapter 320, the venturi assembly 330, the check valve 340, and/or the flow restrictors 565A, 565B, and/or 565C.

It is to be understood that the controller 110 disclosed herein can also receive and send instructions to other devices shown or not shown within the system 100. For example, the valve based water softener system 100 disclosed herein can include one or more additional devices, such as conductivity meters, sodium analyzers, level sensors, and other known sensors and devices in the art, in fluid communication with components of the system 100.

The controller 110 shown in the system 100 may also intelligently manage the fluid flow between the resin bed 154 in the water softener tank 106 and the fluid flow with the brine solution in the brine tank 104 to convert the hard water to desired soft water and recharge the resin within the resin bed 154 periodically. In some instances, the brine solution is provided in the form of salt tablets/beads dipped in water and is used to prepare for the next recharge cycle.

The controller 110 can be provided in the form of a data-processing device configured to transmit and receive data from the valve based water softener system 100. For example, the controller 110 may receive information at a receiver (not shown). A processor (not shown) included in the controller 110 may analyze the received data and determine instructions to be sent back to the valve based water softener system 100. A transmitter (not shown) of the controller 110 may send the instructions from the processor to one or more components of the valve based water softener system 100. The controller 110 can further include a memory (not shown). The memory can be configured to store data received from the valve based water softener system 100. The memory can be implemented as a stand-alone memory unit and/or as part of a processor included in the controller 110. Further, in one non-limiting embodiment, a network 1004 (shown in FIG. 11) may be coupled to the memory, which may include program instructions that are stored in the memory and executable by the processor to perform one or more of the methods described herein.

The network 1004 can be provided in the form of a network interface, a local network, or other communication connection and is not limited to the plurality of communication connections. One skilled in the art will recognize that a communication connection can transmit and receive data using a plurality of communication protocols, including but not limited to: wired, wireless, Bluetooth, cellular, satellite, GPS, RS-485, RF, MODBUS, CAN, CANBUS, DeviceNet, ControlNet, Ethernet TCP/IP, RS-232, Universal Serial Bus (USB), Firewire, Thread, proprietary protocol(s), or other communication protocol(s) as applicable. In some embodiments, the network is located proximate to one or more components of the valve based water softener system 100. The network can include the Internet, intranets, extranets, wide area networks (“WANs”), local area networks (“LANs”), wired networks, wireless networks, cloud networks (such as 1102 shown in FIG. 11), or other suitable networks, or any combination of two or more networks, Ethernet networks, and other types of networks.

The networks, such as 1102 and/or 1104, may be configured to communicate directly or indirectly with a user device 1000 (also shown in FIG. 11), such as a mobile phone having an application.

Turning to FIGS. 11-16, schematic diagrams are provided that depict various fluid flow paths through the system 100.

Generally, in order to soften water using a water softening system, such as the system 100, a fluid (e.g., hard water) is supplied to a water softener system. During operation, hard water passes into the system 100 and through the (e.g., mineral) tank 106. The tank 106 has positively charged calcium and magnesium ions that facilitate exchanging sodium onto negatively-charged resin beads within the resin bed 154. The calcium and magnesium remain within the tank 106 and the remainder of the fluid with sodium ions flows (e.g., softened water) through the outlet 176 and into the rest of the system 100 to then exit the system 100. After many cycles of fluid flowing through the system 100 and the system 100 converting the hard water to softened water, all sodium ions within the tank 106 are exchanged with the magnesium and calcium on the resin beads such that the beads are filled with calcium and magnesium and the tank 106, particularly the resin beads within the resin bed, need to be regenerated.

During the regeneration cycle, the brine tank 104 is used to recharge the tank 106 with sodium from the brine tank solution and displaces calcium and magnesium, which is flushed out of the system (e.g., through the drain manifold 164) during the backwashing cycle. At the end of the regeneration cycle, the backwashing cycle occurs. Backwashing involves the final removal of the hardness of elements that have accumulated in the tank 106 and flushes out of the system (e.g., through the drain manifold 164). Once the regeneration and backwashing cycles are finished, the tank 106 may be rinsed with a rinse cycle where the tank 106 is rinsed with fresh water and the brine tank 104 is loaded so that the system 100 is ready for additional softening cycles. Additionally, the controller 110 may facilitate controlling one or more of the operational cycles.

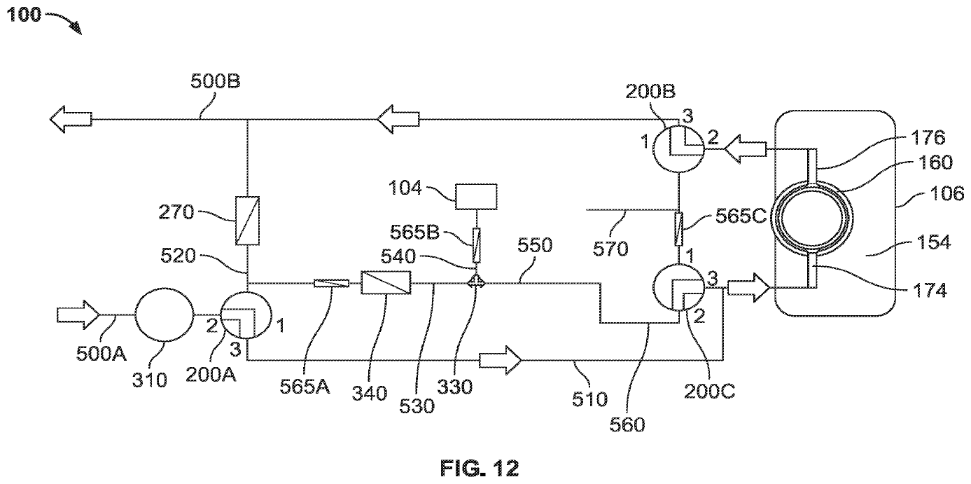

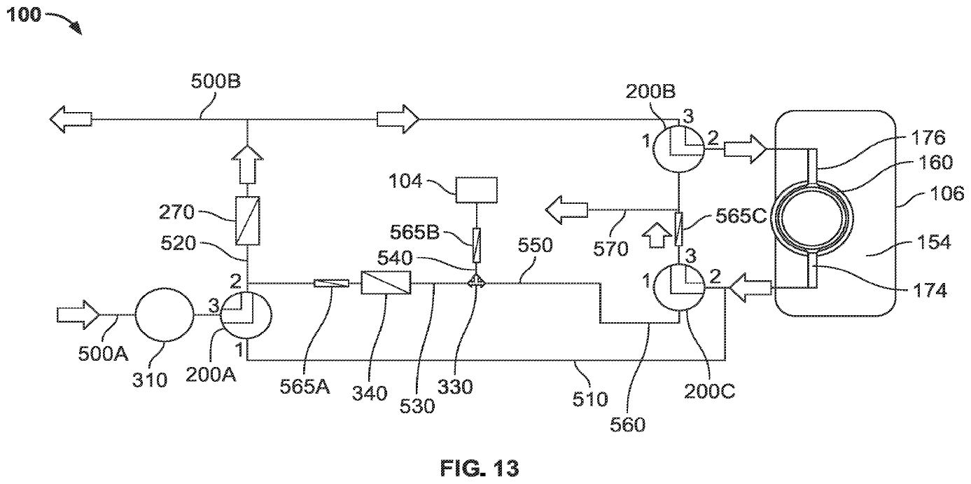

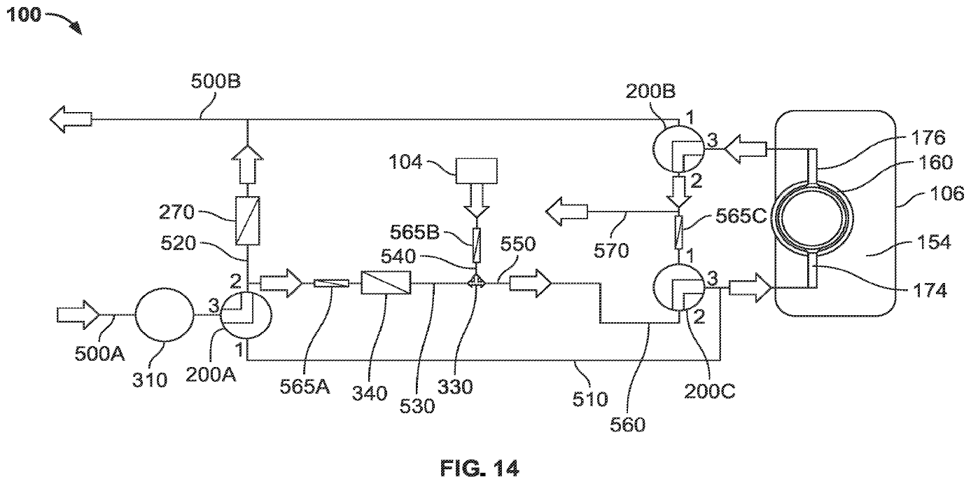

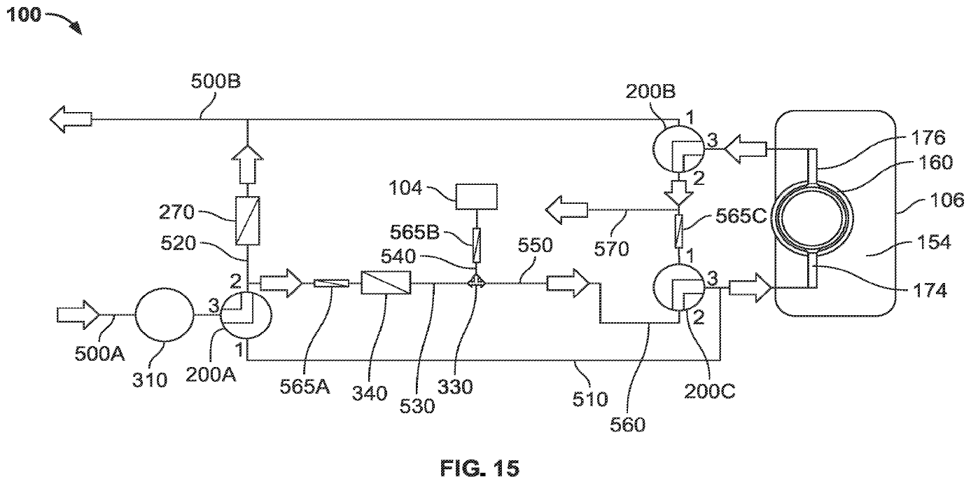

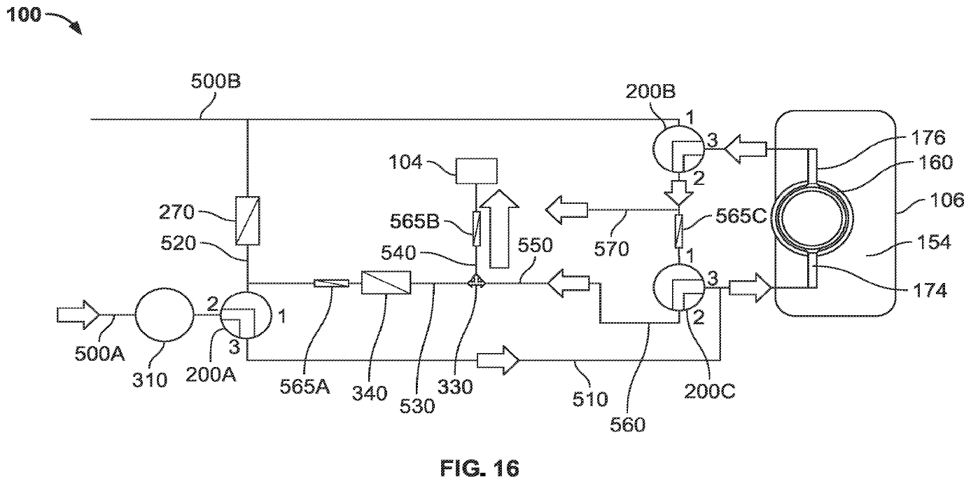

Adjustment of the valve assembly 108 in the water softener system 100 enables the system 100 to operate in varying operational cycles, such as a service cycle (e.g., one instance shown in FIG. 12), a backwash cycle (e.g., one instance shown in FIG. 13), a brine cycle (e.g., one instance shown in FIG. 14), a slow rinse cycle (e.g., one instance shown in FIG. 15), and/or a rapid rinse cycle (e.g., one instance shown in FIG. 16).

Turning now to the specifics of the operation of the system 100, as shown in FIG. 11, hard water is delivered to the water softener system 100 via a make-up line or a hard water supply line 500A. The supply line 500A can include a feed pump (not shown) and the flow sensor 310 for monitoring and controlling fluid flow through the supply line 500A. The supply line 500A can include a first inlet line 510 in fluid communication with the valve assembly 108 via the inlet 174 of the water softener system 100. The first inlet line 510 can include the first valve 200A downstream of the flow sensor 310 and upstream of the water softener tank 106.

After the hard water enters the valve assembly, the water travels into the water softener tank 106 to be treated. The softened water, brine, and/or waste can be removed from the valve based water softener system 100 via a product or outlet line (e.g., soft or treated water line) 500B. The product line 500B is in fluid communication with the outlet 176. The product line 500B can include the second valve 200B for controlling the direction of the fluid flow therethrough.

The supply line 500A can also be in fluid communication with the product line 500B via a bypass line 520. The take-off for the bypass line 520 can be downstream of the feed pump and the first valve 200A. The bypass line 520 further may include the check valve 270. The tie-in for the bypass line 520 can be downstream of the second valve 200B. A bypass cycle may be provided whereby an operational cycle is used at the same time as the regeneration cycle to supply hard water directly to a user without converting the hard water to soft water.

The supply line 500A further may be in fluid communication with an inlet line 530. The take-off for the inlet line 530 is downstream of the first valve 200A and upstream of the third valve 200C. The inlet line 530 may include the flow control restrictor or valve 565A downstream of the first valve 200A and upstream of the check valve 340 (e.g., before the venturi assembly 330). The inlet line 530 can also be in fluid communication with the brine tank 104 via a brine refill line 540. The take-off for the brine refill line 540 is downstream of the check valve 340 and the tie-in for the brine refill line 540 is upstream of the third valve 200C. The brine refill line 540 is in fluid communication with the brine line flow control restrictor 565B and/or the venturi assembly 330. The brine line flow control restrictor 565B may be upstream of the venturi assembly 330 and/or upstream of the port 390.

Additionally, a brine outlet line 550 may be in fluid communication with the water softener system 100 and downstream of the line 540, such that the line 550 facilitates removing the brine fluid from the water softener system 100. The brine refill cycle is an operational cycle for preparing the brine tank 104 by providing a brine solution into the brine tank 104, which recharges the resin solution in a water softener tank 106.

The brine tank 104 can also be in fluid communication with the water softener tank 106 via a brine injection line 560 that engages the inlet line 530. The tie-in for the brine injection line 560 is downstream of the venturi assembly 330 and upstream of the third valve 200C.

A drain line 570 may be in fluid communication with the second valve 200B and the third valve 200C and/or with the drain manifold 164 to facilitate draining any excess fluid or any waste fluid from the water softener tank 106 and/or the system 100. The drain line 570 and/or the drain manifold 164 further may include the flow control restrictor 565c to control the flow of the fluid therethrough.

As shown in FIG. 11, the controller 110 may be in operational communication with at least one of the flow sensor 310, the first valve 200A, the second valve 200B, and/or the third valve 200C, such that the controller 110 may provide operating instructions to each of the valves 200A, 200B, 200C and/or the flow sensor 310.

Further, in one instance, each valve 200A, 200B, and/or 200C is a three-way valve. Each valve 200A, 200B, and/or 200C may operate in a first position (e.g., “Position 1”) for a duration of time before the valve is moved to a second or different position (e.g., “Position 2”). Each valve 200A, 200B, and/or 200C has an inlet with a first outlet and a second outlet. When fluid flows through at least one of the valves 200A, 200B, and/or 200C, there are three pathways for the water to flow. In one instance, the first position of each valve 200A, 200B, and/or 200C refers to the fluid (e.g., water) entering through the inlet of a valve and leaving or exiting through the first outlet of the same valve, and the second position of each valve 200A, 200B, and/or 200C refers to the fluid (e.g., water) entering through the inlet of a valve and exits/passes out of the second outlet of the same valve. Table 1 below summarizes the orientation of the valves 200A, 200B, and 200C during the various operational cycles of the water softener system 100. The orientation of the valves 200A (e.g., “X” in Table 1), 200B (e.g., “Y” in Table 1), and 200C (e.g., “Z” in Table 1) changes the flow of the fluid throughout each valve and throughout the water softener system 100.

Still referring to FIG. 11, the system 100 includes multiple fluid lines and devices for controlling the flow of fluids throughout the system 100. As such, the flow of a fluid through the system 100 can depend on the mode of operation, wherein the mode of operation can be a service cycle, a backwash cycle, a brine draw cycle, a slow rinse cycle, a rapid rinse cycle, a brine tank refill cycle, and/or a bypass cycle. The following embodiments discuss each of the above modes of operation of the water softener system 100.

Turning to FIG. 12, during a service cycle, hard water from the supply line 500a flows through the inlet line 510 into the water softener tank 106. The service cycle is designed to be an operational cycle for converting hard water to soft water using an ion exchange process. Thus, the hard water flows through the flow sensor 310 and through the first valve 200A in a first position and circumvents the third valve 200C in a first position, so that the flow of the hard water is directed to the inlet 174 of the valve head 160. The hard water enters the inlet 174 and flows (e.g., through the conduit 304) into the water softener tank 106. The water softener tank 106 may be at least partially filled with the resin bed 154. As such, the hard water flows into the water softener tank 106, comes into contact with the top of the resin bed 154, and passes down through the resin bed 154 toward the bottom of the water softener tank 106. The resin bed 154 removes hardness from the hard water in the form of calcium ions and magnesium ions and replaces them with sodium ions, thereby softening the hard water. The softened water then flows up into the conduit 306. The softened water exits the water softener tank 106 through the outlet 176 of the valve head 160. The softened water flows through the second valve 200B in a first position and continues to flow out of the water softener system 100 via the product line 500B.

Also, during the service cycle, the water softener system 100 may be operated with a flow rate between about 3 liters per minute to about 16 liters per minute. In one instance, the water softener system 100 may be operated with a flow rate between about 7 liters per minute to about 12 liters per minute. In other instances, the water softener system 100 may be operated with a flow rate between about 9 liters per minute to about 10 liters per minute. In one instance, the water softener system 100 may be operated with a flow rate of about 2.38 gallons per min (GPM) or about 9 liters per minute (LPM) for a given duration of time.

As described above, during the service cycle, as the hard water flows through the resin bed 154, sodium ions from the resin bed 154 are swapped with calcium and magnesium ions from the hard water. Thus, the resin bed 154 can become exhausted (i.e., loaded with calcium and magnesium ions). The resin bed 154 can be regenerated through a regeneration cycle, which uses a regenerant solution that removes ions that were picked up by the resin bed 154 during the service cycle. The regeneration cycle may include one or more steps or cycles as described below. The regeneration cycle is an operational cycle to recharge resin solution stored in the water softener tank 106, which is depleted over a period of time while converting the hard water to soft water.

Turning to FIG. 13, a step in the regeneration cycle may be a backwash cycle. The backwash cycle is designed to be a final removal of elements (e.g., dirt) that have accumulated in the tank and flush the elements to the drain. The backwash cycle cleans the resin solution so that it is prepared for recharge by doing a reverse flow from the outlet to the inlet. The resin solution is contained in a resin tank that includes a resin bed. During the backwash cycle, the resin bed rises, and impurities are cleaned off the bed, which have accumulated over a period of the service cycle.

During the backwash cycle, the feed pump (not shown) pumps a cleaning fluid, such as water, through the first valve 200A, in position 2, through the bypass line 520 into the water softener tank 106 through the second valve 200B, in position 1, so that the cleaning fluid is directed to the outlet 176. The cleaning fluid enters the outlet 176 and flows (e.g., through at least one conduit 304, 306 and/or 308) into the water softener tank 106 and into the resin bed 154. The cleaning fluid flows up through the resin bed 154, thereby loosening impurities, such as solid contaminants, which were collected in the resin bed 154 during the service cycle. The resin bed 154 may be comprised of small particles or beads. Thus, high flow rates can cause some of the resin bed 154 to become entrained with the cleaning fluid. Therefore, at least one flow restrictor may be included to reduce the flow rate of the cleaning fluid so that the resin bed 154 is not blown out of the water softener tank 106. Further, in some embodiments, the water softener tank 106 can include one or more resin traps to prevent the loss of resin. The resin traps can be placed in an opening in one or more of the inlet 174, the outlet 176, the opening 178, and/or within one or more conduits 304, 306, and/or 308. The resin traps can be provided in the form of a mesh covering, a strainer, a sieve, or any other known particle filter in the art. Thus, as the cleaning fluid leaves the water softener tank 106, any entrained resin particles are prevented from exiting.

The spent cleaning fluid containing impurities is directed through the inlet 174 and sent to waste via the drain line 570. Thus, the third valve 200C is in position 1, so that the spent cleaning fluid flows out of the water softener system 100.

Also, during the backwash cycle, the water softener system 100 may be operated with a flow rate of between 3 liters per minute (LPM) to about 7 LPM for a given duration of time of between about two minutes to about six minutes. In another instance, the water softener system 100 may be operated with a flow rate of between 4 liters per minute (LPM) to about 6 LPM for a given duration of time of between about two minutes to about six minutes. In one specific embodiment, the water softener system 100 may be operated with a flow rate of about 1.4 gallons per minute (GPM) or about 5.3 liters per minute (LPM) for a given duration of time of about four minutes.

After the backwash cycle, the resin bed 154 is still loaded with calcium and magnesium ions. Thus, the hardness collected by the resin bed 154 must still be removed. As such, a brine draw cycle, which uses a sodium-rich solution to regenerate the resin bed 154, may be a second step in the regeneration cycle.

Turning to FIG. 14, during the brine draw cycle, the feed pump (not shown) pumps a dilution fluid, such as water, through the supply line 500A and through the first valve 200A, which is in position 2. The brine draw cycle is an operational cycle to draw brine solution from the brine tank and mix the brine solution with incoming hard water. The resulting mixture is diluted and flows down through the resin solution and onto the resin bed and flows down into the water softener tank.

A portion of the dilution fluid may be directed through the first valve 200A in position 2 and into the bypass line 520 to continue through to the product line 500B to exit the water softener system 100.

In a preferred embodiment, the dilution fluid is soft water so that the dilution fluid does not further exhaust the resin bed 154. The dilution fluid is mixed with a sodium-rich fluid to form a brine solution. Thus, the check valve 340 is opened so that the sodium-rich fluid contained in the brine tank 104 can be injected into the line 540, thereby mixing with the dilution fluid to form the brine solution. The brine injection line 540 can include the venturi assembly 330 to create a vacuum that draws the sodium-rich fluid from the brine tank 104. The brine injection line 540 can also include the flow restrictor 565C to control the sodium-rich fluid's flow rate. The brine injection line 540 can include a second flow meter (not shown) for monitoring the flow rate of the sodium-rich solution.

In some instances, the brine solution is drawn at a rate of between about 0.2 gallons per liter to about 2 gallons per liter, and mixed with the dilution fluid, having a flow rate of between about 2 gallons per liter to about 4 gallons per liter. In other instances, the brine solution is drawn at a rate of between about 0.7 gallons per liter to about 1.3 gallons per liter, and mixed with the dilution fluid, having a flow rate of between about 3 gallons per liter to about 4 gallons per liter. In one specific embodiment, the brine solution is drawn at a rate of approximately 0.25 gallons per minute (GPM) or 0.95 gallons per liter, and mixed with the dilution fluid, having a flow rate of approximately 1 GPM or approximately 3.79 gallons per liter. Thus, the ratio of the sodium-rich fluid to the dilution fluid is about 1:4. However, it is to be understood that the brine solution may be provided at any ratio.

The brine solution flows through the line 560 and through the third valve 200C, in position 1, into the inlet 174 and into the water softener tank 106. The brine solution passes down through the resin bed 154 and is removed from the tank 106. As the brine solution passes through the resin bed 154, the sodium ions in the brine solution are swapped with the calcium and magnesium ions. Thus, the water leaving the water softener tank 106 is now rich with calcium and magnesium ions (i.e., hard water). The hard water is sent to waste through the outlet 176 and through the second valve 200B in position 2. The hard water is directed to the drain line 570 to exit the water softener system 100.

In one embodiment, the brine draw cycle may run for a specified time period (e.g., between about 10 minutes to about 30 minutes, or between about 15 minutes to about 25 minutes, or about 20 minutes) at a flow rate of about 0.08+/−0.13 gallons per minute or about 0.3+/−0.49 gallons per liter. However, in another embodiment, the brine draw cycle time is based on sodium levels and/or the conductivity levels of the water softener tank 106. Thus, the system 100 can include one or more sensors for measuring conductivity and/or sodium. Following the brine draw cycle, a slow rinse cycle is used to displace excess residual brine solution from the resin bed 154. The slow or rapid rinse cycle may refer to an operational cycle to wash out residual/excessive brine solution by flowing water through the resin bed 154.

Turning to FIG. 15, in one embodiment, the slow rinse cycle operates similarly to the brine draw cycle, except for the flow of the sodium-rich solution from the brine tank 104 is blocked by closing the check valve 340. Thus, only the dilution fluid is fed to the water softener tank 106.

In one embodiment, the slow rinse cycle may run for a specified period of time, for example, between about 20 minutes to about 60 minutes, or about 30 minutes to about 50 minutes, or about 40 minutes. The flow rate of the dilution solution may be maintained at the substantially same flow rate as when the brine draw cycle was run, or the flow rate may be about 0.13 gallons per minute or about 0.49 gallons per liter (or between about 0.2 gallons per liter to about 0.6 gallons per liter, or between about 0.4 gallons per liter to about 05 gallons per liter). However, the flow rate of the dilution fluid may be increased or decreased depending on the needs of the water softener system 100. The water from the slow rinse cycle may be sent to waste.

In mixed bed systems, the slow rinse cycle may help the resin bed 154 separate back into the different layers (i.e., the heavier resin will settle at the bottom of the resin bed 154, and the lighter resin will settle on top of the heavier resin). However, there may still be some residual brine solution in the resin bed 154. Thus, a rapid rinse cycle can help remove any remaining brine solution from the water softener tank 106.

Turning to FIG. 16, during the rapid rinse cycle, the main difference from the slow rinse cycle is that the flow rate of the dilution fluid is increased. Typically, the flow rate of the dilution fluid is increased to the same flow rate of the make-up fluid during the service cycle. The increased flow rate of the dilution fluid helps remove any lingering brine solution from the resin bed 154, especially in “dead” areas of the water softener tank 106 (i.e., areas that may not receive as much fluid circulation as other areas of the water softener tank 106 due to tank geometry, fluid injection locations, etc.). The water from the rapid rinse cycle may be sent to waste.

In order to have the rapid rinse cycle operate at a flow rate similar to the service cycle, the fluid flows through the first valve 200A in position 1 and the third valve 200C is in position 1, so that the fluid flows through the inlet line 510 to enter the inlet 174. The fluid then flows through the water softener tank 106 and exits through at least one of the inlet 174 and/or the outlet 176. The fluid flowing through the third valve 200C flows back towards the brine tank 104, and the fluid flowing through the second valve 200B in position 2 flows to the drain line 570.

In one embodiment, the rapid rinse cycle may run for a specified period of time, for example, between about 2 minutes to about 8 minutes, or about 3 minutes to about 6 minutes, or about 4 minutes or about 5 minutes. However, the run time of the rapid rinse cycle may also be controlled based on a measured conductivity value of the fluid in/leaving the water softener tank 106. After the rapid rinse cycle is completed, the resin bed 154 is regenerated. Thus, the regeneration cycle may be complete. However, the brine tank 104 may need to be refilled.

Table 2 below summarizes the orientation of the valves 200A, 200B, and 200C during the above cycles. Table 2 further includes example run times and flow rates for each cycle. However, it is to be understood that each cycle's run time and flow rate may vary depending on the embodiment.

TABLE 2

| | | Flow | | | | | |
|---|---|---|---|---|---|---|---|
| | | Rate | | | | | |
| | | (GPM- | | | | | |
| | | gallons | | Port Size | | | |
| Cycle | Flow | per | Duration | (inches or | First Valve | Second | Third Valve |
| # | Cycle | minute) | (mins) | centimeters) | 200A | Valve 200B | 200C |
| A | Service | 2.38 | Based on | ½ in. | Position 1 | Position 1 | Position 1 |
| | | | Usage | (1.27 cm) | | | |
| B | Backwash | 1.4 | 4 | ½ in. | Position 2 | Position 1 | Position 2 |
| | | | | (1.27 cm) | | | |
| C | Brine | 0.08 + 0.13 | 20 | ¼ in. | Position 2 | Position 2 | Position 1 |
| | Draw | | | (0.635 cm) | | | |
| | | | | or ⅜ in. | | | |
| | | | | (0.375 cm) | | | |
| D | Slow | 0.13 | 40 | ¼ in. | Position 2 | Position 2 | Position 1 |
| | Rinse | | | (0.635 cm) | | | |
| | | | | or ⅜ in. | | | |
| | | | | (0.375 cm) | | | |
| E | Rapid | 2.38 | 3 or 4 | ½ in. | Position 1 | Position 2 | Position 1 |
| | Rinse | | | (1.27 cm) | | | |

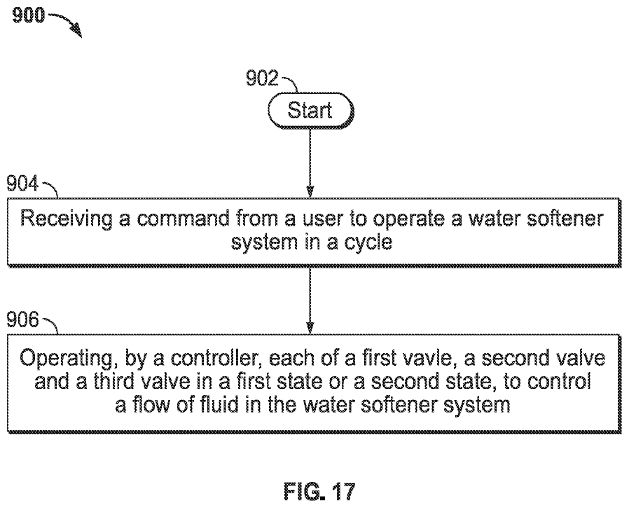

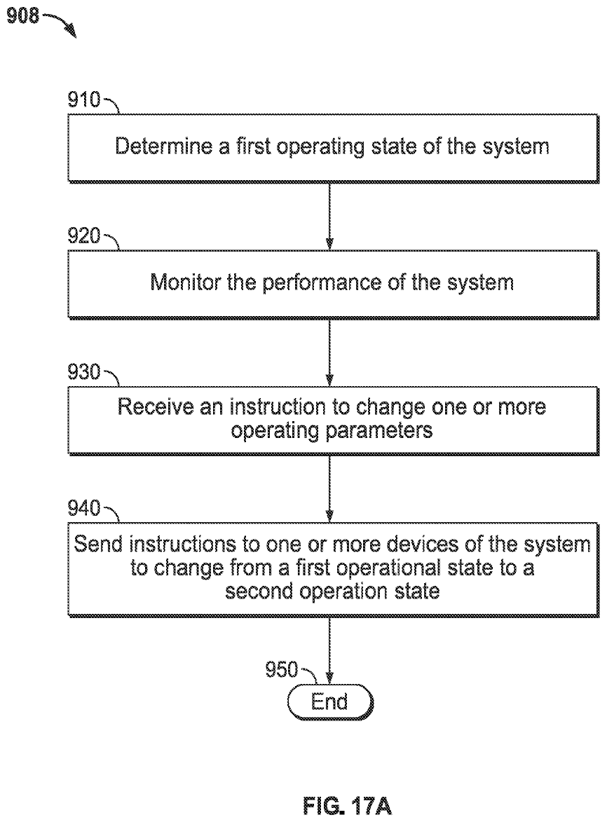

Referring now to FIG. 17, a method 900 of controlling operation of the water softener system 100 in any of the operational states described herein is depicted. The method flow diagram 900 starts at step 902. At step 904, the method flow diagram 900 receives a command from a user to operate a water softener system 100 in an operational cycle. In an exemplary embodiment, the user may provide the command from an application stored in a user (e.g., mobile) device or display 1000 (shown in FIG. 11) that communicates with the water softener system 100. In another exemplary embodiment, the user may provide the command from a user interface provided on or in conjunction with the water softener system 100.

Further, the operational cycle may comprise one or more of a service cycle, a backwash cycle, a brine draw cycle, a slow rinse cycle, a rapid rinse cycle, a brine tank refill cycle, and/or a bypass cycle.

In some embodiments, the command is received from the mobile device 1000, communicated through a cloud network 1002 and/or a WiFi network 1004 by the controller 110. The first valve 200A, the second valve 200B, and/or the third valve 200C are thereby adjusted via the controller 110.

At step 906, based on the command, the controller 110 automatically operates each of a first valve 200A, a second valve 200B, and/or a third valve 200C in a first state (e.g., position 1) or a second state (e.g., position 2), based on the cycle. The valve configuration is designed to control a flow of fluid through the water softener system 100 as explained above with respect to FIGS. 11 to 16. The cycle may restart or rerun and/or one or more additional cycles.

Although the method 900 is described herein as being automatic, the method 900 in an alternative embodiment can be performed manually.

Moreover, turning to FIG. 17A, a method 908 of automating the operation of a water softener system 100 may be utilized in any of the embodiments disclosed herein.

At block 910, the controller 110 determines a first operational state of the system. The operational state may be a service cycle, a backwash cycle, a brine draw cycle, a slow rinse cycle, a rapid rinse cycle, a brine tank refill cycle, or a bypass cycle.

At block 920, the controller 110 monitors the performance of the system. The monitoring operation can include receiving and monitoring one or more pieces of information from the system, such as flow rates, a period of time, conductivity levels, sodium levels, tank levels, or any other performance metrics for water softening systems known in the art.

At block 930, the controller 110 can receive an instruction to change one or more operating parameters of the system. The operating parameters can include one or more of a flow rate, an orifice size, a valve position, or any other operating parameter disclosed herein.

At block 940, the controller 110 sends instructions to one or more components of the system 100 to change from a first operational state to a second operation state, thereby ending the method 908 at block 950. For example, the controller 110 may send instructions to one or more of the valve(s) 200A, 200B, and/or 200C of the system 100 to change from a position 1 to a position 2 or from position 2 to position 1.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

1. A water softener system, comprising:
a housing;
a brine tank disposed within the housing;
a water softener tank disposed within the housing and in fluid communication with the brine tank; and
a valve assembly in fluid communication with the water softener tank and having a first valve, a second valve and a third valve, each valve having a valve inlet, a first outlet, and a second outlet;
wherein the valve assembly does not include any per- or polyfluorinated substances.

2. The water softener system according to claim 1, wherein the housing includes a cover removably coupled to a base and defining an enclosure to retain at least a portion of the water softener system, and the water softener tank is disposed within the housing and is in fluid communication with the valve assembly, which protrudes upwardly from an exterior of the housing.

3. The water softener system according to claim 1, wherein the brine tank includes sodium designed to recharge the water softener.

4. The water softener system according to claim 1, wherein the water softener tank includes a container having a resin bed to facilitate treatment of fluid flowing therethrough.

5. The water softener system according to claim 1, wherein the valve assembly is engaged with the water softener tank via a threaded connection.

6. The water softener system according to claim 1, wherein the valve assembly is provided in the form of a valve head, a connector plate, a drain manifold, a main manifold, and the first valve, the second valve, and the third valve defining a valve sub assembly.

7. The water softener system according to claim 6, wherein the first valve, the second valve, and the third valve are one of a motorized 3-way L-port valve or a 3-way T-port valve.

8. The water softener system according to claim 6, further comprising a controller for operating each of the first valve, the second valve, and the third valve in a first state or a second state, to control a flow of fluid in the water softener system.

9. The water softener system according to claim 6, wherein the valve sub assembly is in fluid communication with the drain manifold and the main manifold.

10. The water softener system of claim 8, wherein the controller facilitates operating the water softener system in one of a service cycle, a backwash cycle, a brine draw cycle, a slow rinse cycle, a rapid rinse cycle, a brine tank refill cycle, and/or a bypass cycle.

11. The water softener system of claim 10, wherein the first valve, the second valve, and the third valve are operated in a first state during the service cycle, wherein each valve has an inlet open, a second outlet open, and a first outlet closed.

12. The water softener system of claim 10, wherein the first valve and the third valve are operated in a second state, wherein the first valve and the third valve have open inlets, open first outlets, and closed second outlets, and the second valve is operated in the first state, wherein the second valve has an open inlet, a closed first outlet, and an open second outlet during the backwash cycle.

13. A valve assembly for a water softener system, comprising:
a valve head having a body with an inlet and an outlet that are substantially axially aligned, the valve head being in fluid communication with a water softener tank;
a connector plate having a plurality of connectors to facilitate fluid communication between the water softener tank and the inlet and the outlet of the valve head;
a valve sub assembly defined by a first valve, a second valve, and a third valve;
a main manifold having a housing with three substantially cylindrical conduits, a flow sensor, and a venturi assembly, the main manifold designed to facilitate the flow of fluid between the first valve, the second valve, and the third valve, and the water softener tank; and
a controller that selectively operates the first valve, the second valve, and the third valve in various operational states.

14. The valve assembly of claim 13, wherein the valve sub assembly is in fluid communication with the inlet and the outlet of the valve head, which is coupled to the water softener tank.

15. The valve assembly of claim 14, wherein the main manifold includes a port in fluid communication with a brine tank.

16. The valve assembly of claim 13, wherein at least one of the first valve, the second valve, and the third valve has a coupling plate.

17. The valve assembly of claim 13, wherein the water softener system is operated in at least one of a service cycle, a backwash cycle, a brine draw cycle, a slow rinse cycle, a rapid rinse cycle, a brine tank refill cycle, or a bypass cycle.

18. A method of operating a water softener system having a tank, and at least three valves coupled between a manifold and a valve head, the method comprising:
determining a first operating state of the system;
monitoring the performance of each of the three valves via the controller;
receiving an instruction from the controller to change the first operating state of at least one of the three valves to a second operating state of the system that is different than the first operating state; and
changing at least one of three valves to the second operating state based on the instruction.

19. The method according to claim 18, wherein the operating state is at least one of a service cycle, a backwash cycle, a brine draw cycle, a slow rinse cycle, or a rapid rinse cycle.

20. The method according to claim 18, wherein the controller includes a circuit board that is a 4 channel relay.
